(19) United States
(12) Patent Application Publication
(10) Pub. No.: US 2002/0124025 A1
(43) Pub. Date: Sep. 5, 2002

(54) Scanning and outputting textual information in web page images

(75) Inventors: Janani Janakiraman, Austin, TX (US); Rabindranath Dutta, Austin, TX (US)

Correspondence Address: Kelly K. Kordzik, 100 Congress Avenue, Suite 800, Austin, TX, 78701, US

(73) Assignee: International Business Machines Corporataion, Armonk, NY (US)

(21) Appl. No.: 09/798,280

(22) Filed: Mar. 1, 2001

(51) Int. Cl. G06F 17/21

(52) U.S. Cl. 707/526; 707/501.1

(57) ABSTRACT

A method, system and computer program product for scanning and outputting textual information in web page images. A file, e.g., HTML file, may be scanned for an image file tag which may identify an image file Upon identifying an image file tag, i.e. an image file, the web browser may be configured to open the image file identified by the image file tag and transfer the image associated with the opened image file to an Optical Character Recognition (OCR) scanning program. The image received by the OCR scanning program may be scanned for textual information in the image. The textual information scanned may then be transmitted to the web browser. Upon receiving the textual information, the web browser may be configured to output the textual information to a Braille display and/or speech synthesizer and/or speaker and/or display.

### CROSS REFERENCE TO RELATED APPLICATIONS

The present invention is related to the following U.S. patent applications which are hereby incorporated herein by reference:

Ser. No. 09/______, “Apparatus To Convey Depth Information In Graphical Images And Method Therefor” (Attorney Docket No. AUS9-2001-0094US1);

Ser. No. 09/______, “Apparatus For Outputting Textual Renditions Of Graphical Data And Method Therefor” (Attorney Docket No. AUS9-2001-0095US1); and

Ser. No. 09/______, “Extracting Textual Equivalents of Multimedia Content Stored in Multimedia Files” (Attorney Docket No. AUS9-2001-0097US1).

### TECHNICAL FIELD

The present invention relates to the field of assisting individuals with disabilities through technology, and more particularly to scanning and outputting textual information in web page images in order to promote accessibility to individuals with disabilities.

### BACKGROUND INFORMATION

Congress passed the “Assistive Technology Act of 1998” to promote the assistance of individuals with disabilities through technology such as encouraging the promotion of technology that will allow individuals with disabilities to partake in the information technology, e.g., Internet.

The development of computerized distribution information systems, such as the Internet, allows users to link with servers and networks, and thus retrieve vast amounts of electronic information that was previously unavailable using conventional electronic mediums. Such electronic information increasingly is replacing the more conventional means of information such as newspapers, magazines and television.

Users may be linked to the Internet through a hypertext system of servers commonly referred to as the World Wide Web (WWW). With the World Wide Web, an entity having a domain name may create a “web page” or “page” that can provide information and to a limited degree some interactivity.

A computer user may “browse”, i.e. navigate around, the WWW by utilizing a suitable web browser, e.g., Netscape Navigator™, Internet Explorer™, and a network gateway, e.g., Internet Service Provider (ISP). A web browser allows the user to specify or search for a web page on the WWW and subsequently retrieve and display web pages on the user's computer screen. Such web browsers are typically installed on personal computers or workstations to provide web client services, but increasingly may be found on wireless devices such as cell phones.

The Internet is based upon a suite of communication protocols known as Transmission Control Protocol/Internet Protocol (TCP/IP) which sends packets of data between a host machine, e.g., server computer on the Internet commonly referred to as a web server, and a client machine, e.g., a user's computer connected to the Internet. The WWW is a network of computers that use an Internet interface protocol which is supported by the same TCP/IP transmission protocol.

A web page may typically include images, e.g., navigational menus, pop-up windows/menus, charts and graphs. Images may be specified in a HyperText Markup Language (HTML) file that is sent from the web server to the client machine. In the HTML source code, images may be specified in various files of different formats. For example, an image may be represented in a Graphics Interchange Format (GIF), Joint Photographic Experts Group (JPEG) and Portable Network Graphics (PNG) file format. The HTML file may then be parsed by the web browser in order to display the images and graphics on the client machine.

When the web browser on the client machine is configured to operate in what is commonly referred to as “text only” mode, the web browser may only display the content of the attributes, e.g., ALT attributes, associated with the image files specified in the HTML file instead of displaying the images themselves. For example,

<IMG SRC=“advertising.gif”ALT=“Click Here!”>

in the HTML source code may indicate that there exists an attribute, e.g., ALT=“Click Here!”, that provides the textual information of “Click Here!” when images are turned off in the web browser, i.e. when the web browser is operating in “text only” mode. That is, in place of the image, e.g., advertising banner ad, there will appear the text “Click Here!” in the place holder for the image as illustrated in FIG. 1. FIG. 1 illustrates an example of an image 103, e.g., advertising banner ad, placed in a place holder 101 on the web page when the web browser is not operating in “text only” mode. When images are turned off in the web browser, i.e., when the web browser is operating in “text only” mode, an attribute 102, e.g., “Click Here!”, may be placed in the place holder 101 for the image on the web page instead of the image 103, e.g., advertising banner ad.

Computer users who are visually impaired may have the textual information, e.g., ALT attributes, that is displayed when the web browser is operating in “text only” mode outputted to a speech synthesizer and/or speaker so that they may able to hear the textual information about the images. Furthermore, computer users who are visually impaired may have the textual information, e.g., ALT attributes, that is displayed when the web browser is operating in “text only” mode outputted to a Braille display so that they may be able to read the textual information about the images.

Unfortunately, the attributes, e.g., ALT attributes, may not provide enough textual information, e.g., “Click Here!”, to adequately describe the images, e.g., advertising banner ad, associated with the attributes, e.g., ALT attributes, when the web browser operates in “text only” mode.

It would therefore be desirable to scan and output the textual information in web page images in order to promote accessibility to individuals with disabilities such as individuals who are visually impaired.

### SUMMARY

The problems outlined above may at least in part be solved in some embodiments by an Optical Character Recognition (OCR) scanning program that scans web page images for textual information and then transmits that textual information to a web browser that may then output the textual information to a Braille display and/or a speech synthesizer and/or a speaker and/or a display.

In one embodiment, a method for scanning and outputting textual information in web page images comprises the step of a web server forwarding an HTML file specifying one or more image files to a web browser in a client. The web browser may be configured to scan line by line of the HTML source code for an image file tag which identifies a particular image file. Upon identifying an image file tag, i.e. an image file, the web browser may be configured to open the image file identified by the image file tag and transfer the image associated with the opened image file to an Optical Character Recognition (OCR) scanning program. The image received by the OCR scanning program may be scanned for textual information in the image. The textual information scanned may then be transmitted to the web browser.

In another embodiment of the present invention, upon receiving the textual information, the web browser may be configured to output the textual information to a Braille display and/or speech synthesizer and/or speaker and/or display.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a web page image and an ALT attribute that provides textual information for that image when the web browser operates in “text only” mode;

FIG. 2 illustrates a network system configured in accordance with the present invention;

FIG. 3 illustrates an embodiment of the present invention of a client in a network system;

FIG. 4 is a flowchart of a method for scanning and outputting textual information in web page images;

FIG. 5 illustrates a web page image that was scanned and the textual information in the image scanned that was outputted to a display by a web browser.

### DETAILED DESCRIPTION

The present invention comprises a method, system and computer program product for scanning and outputting textual information in web page images. In one embodiment of the present invention, a method comprises the step of a web server forwarding an HTML file specifying one or more image files to a web browser in a client. The web browser may be configured to scan line by line of the HTML source code for an image file tag which identifies a particular image file. Upon identifying an image file tag, i.e. an image file, the web browser may be configured to open the image file identified by the image file tag and transfer the image associated with the opened image file to an Optical Character Recognition (OCR) scanning program. The image received by the OCR scanning program may be scanned for textual information in the image. The textual information scanned may then be transmitted to the web browser. Upon receiving the textual information, the web browser may be configured to output the textual information to a Braille display and/or speech synthesizer and/or speaker and/or display

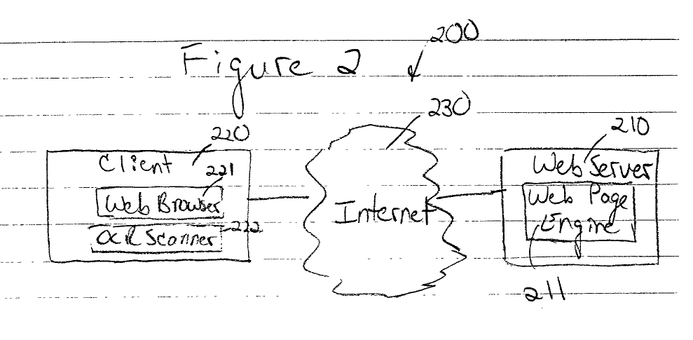

FIG. 2—Network System

FIG. 2 illustrates an embodiment of the present invention of a network system 200. Network system 200 may comprise a web server 210 connected to a client 220 via the Internet 230. The Internet 230 may refer to a network of computers. It is noted that network system 200 may comprise a plurality of clients 220 connected to web server 210 via the Internet 230 and that FIG. 2 is illustrative.

Web server 210 may comprise a web page engine 211 for maintaining and providing access to an Internet web page which is enabled to forward a Hyper-Text Mark-up Language (HTML) file to a web browser 221 of client 220. The HTML file may specify images, e.g., graphical representations of texts (including symbols), image map regions, animation (e.g., animated GIFs), applets and programmatic objects, ASCII art, frames, scripts, images used as list bullets, spacers, graphical buttons, stored in various file formats, e.g., GIF, JPEG, PNG.

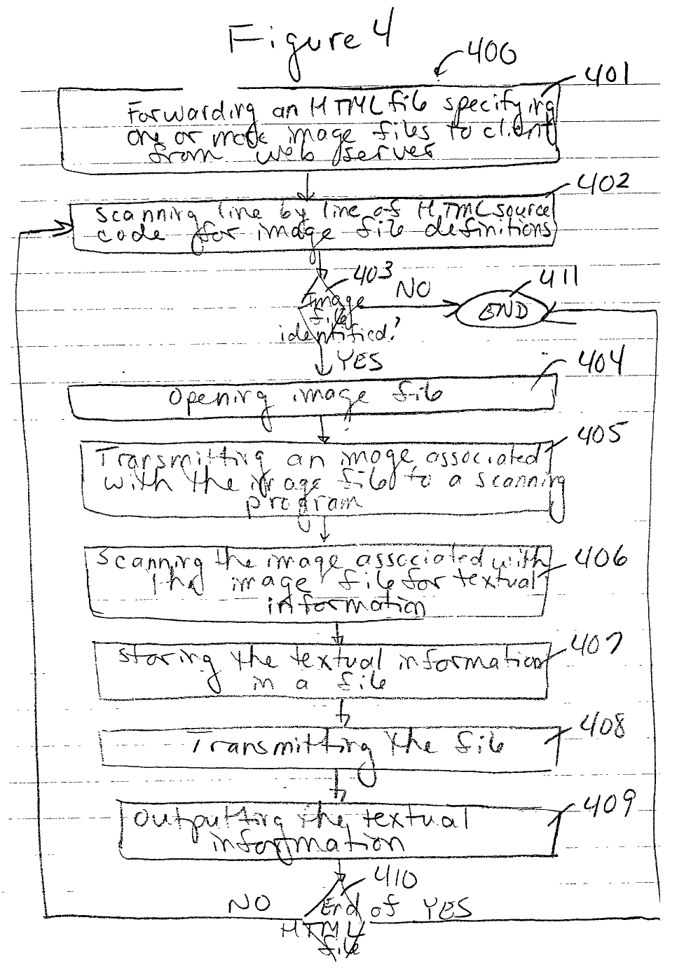

As stated above, the HTML file sent to web browser 221 from web page engine 211 may specify image files, e.g., GIF, JPEG, PNG, that comprise image content. When web browser 221 operates in “text only” mode, web browser 221 may be configured to open an image file and transmit the image stored in the image file to an Optical Character Recognition (OCR) scanning program 222, e.g., Prime OCR, as discussed in greater detail in the description of FIG. 4. OCR scanning program 222 may be configured to scan the image received from web browser 221 and then transmit the textual information in the image received to web browser 221. Web browser 221 may be configured for communicating with the Internet 230 and for reading and displaying the textual information in the images on web pages. While the illustrated client engine is a web browser 221, those skilled in the art will recognize that other client engines may be used in accordance with the present invention. In one embodiment, OCR scanning program 222 may be a plug-in to web browser 221. In another embodiment, OCR scanning program 222 may be directly incorporated as an option in web browser 221. In another embodiment, OCR scanning program 222 may reside in web server 210.

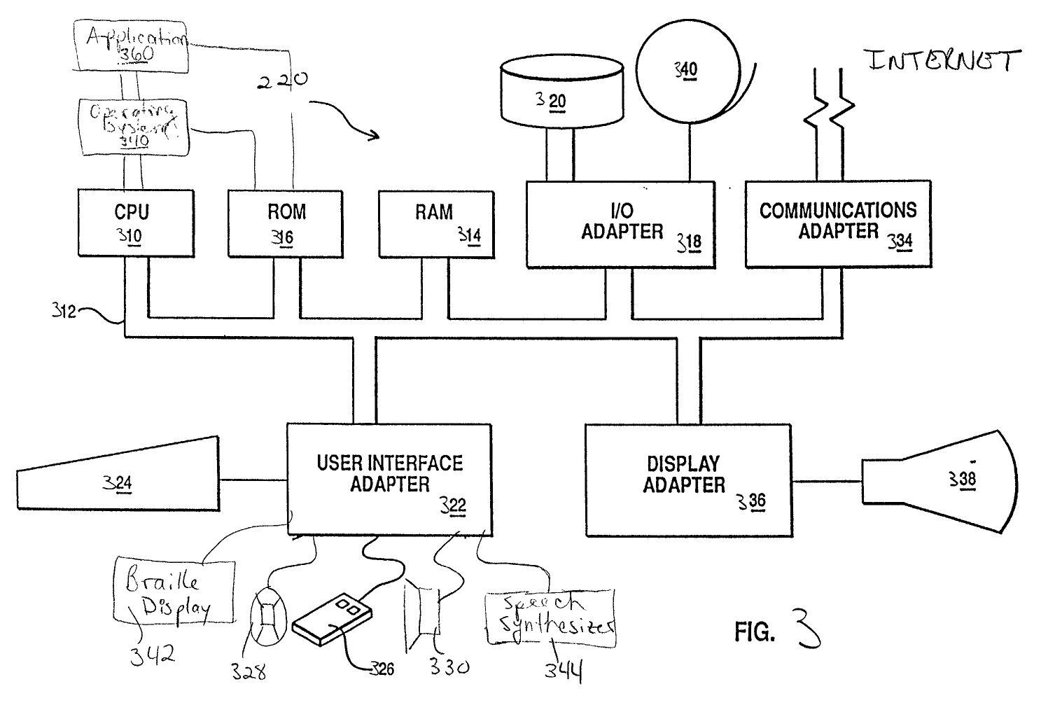

FIG. 3—Hardware Configuration of Client

FIG. 3 illustrates a typical hardware configuration of client 220 which is representative of a hardware environment for practicing the present invention. Client 220 has a central processing unit (CPU) 310, such as a conventional microprocessor, coupled to various other components by system bus 312. An operating system 340, runs on CPU 310 and provides control and coordinates the function of the various components of FIG. 3. Application 360, e.g., web browser 221 with OCR scanning program 222 as a plug-in to web browser 221, web browser 221 with OCR scanning program 222 directly incorporated as an option in web browser 221, runs in conjunction with operating system 340 and provides output calls to operating system 340 which implements the various functions to be performed by the application 360. Read only memory (ROM) 316 is coupled to system bus 312 and includes a basic input/output system (“BIOS”) that controls certain basic functions of client 220. Random access memory (RAM) 314, I/O adapter 318, and communications adapter 334 are also coupled to system bus 312. It should be noted that software components including operating system 340 and application 360 are loaded into RAM 314 which is the computer system's main memory. I/O adapter 318 may be a small computer system interface (“SCSI”) adapter that communicates with disk units 320, e.g., disk drive, and tape drives 340. It is noted that the method for scanning and outputting the textual information in web page images when web browser 221 is operating in “text only” mode as described in FIG. 4 may be implemented by web browser 221 which may reside in application 360 or disk units 320. In one embodiment, OCR scanning program 222 may be a plug-in to web browser 221. In another embodiment, OCR scanning program 222 may be directly incorporated as an option in web browser 221. It is further noted that the method for scanning and outputting the textual information in web page images when web browser 221 is operating in “text only” mode as described in FIG. 4 may be implemented by OCR scanning program 222 in conjunction with web browser 221 where both OCR scanning program 222 and web browser 221 may reside in application 360 or disk units 320. Communications adapter 334 interconnects bus 312 with the Internet 230 enabling client 220 to communicate with the Internet 230. Input/Output devices are also connected to system bus 312 via a user interface adapter 322 and a display adapter 336. Keyboard 324, trackball 328, mouse 326, speech synthesizer 344, speaker 330 and Braille display 342 are all interconnected to bus 312 through user interface adapter 322. Event data may be input to client 220 through keyboard 324, trackball 328 and mouse 326. A display monitor 338 is connected to system bus 312 by display adapter 336. In this manner, a user is capable of inputting to client 220 through keyboard 324, trackball 328 or mouse 326 and receiving output from client 220 via display 338, speaker 330, speech synthesizer 344 and Braille display 342.

Preferred implementations of the invention include implementations as a computer system programmed to execute the method or methods described herein, and as a computer program product. According to the computer system implementations, sets of instructions for executing the method or methods are resident in the random access memory 314 of one or more computer systems configured generally as described above. Until required by client 220, the set of instructions may be stored as a computer program product in another computer memory, for example, in disk drive 320 (which may include a removable memory such as an optical disk or floppy disk for eventual use in disk drive 320). Furthermore, the computer program product can also be stored at another computer and transmitted when desired to the user's work station by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

FIG. 4—Method for Scanning and Outputting the Textual Information in Web Page Images

FIG. 4 illustrates a flowchart of one embodiment of the present invention of a method 400 scanning and outputting the textual information in web page images. As stated in the Background Information section, when the web browser on the client machine is configured to operate in what is commonly referred to as “text only” mode, the web browser may only display the content of the attributes, e.g., ALT attributes, associated with the image files specified in the HTML file instead of displaying the images themselves. Unfortunately, the attributes, e.g., ALT attributes, may not provide enough textual information, e.g., “Click Here!”, to adequately describe the images, e.g., advertising banner ad, associated with the attributes, e.g., ALT attributes, when the web browser operates in “text only” mode. It would therefore be desirable to scan and output the textual information in web page images in order to promote accessibility to individuals with disabilities such as individuals who are visually impaired. Method 400 is a method for scanning and outputting the textual information in images in order to promote accessibility to individuals with disabilities.

In step 401, web page engine 211 of web server 210 may be configured to forward an HTML file specifying one or more image files to web browser 221 of client 220 so that web browser 221 of client 220 may output the textual information in the images in the one or more image files to display 238, Braille display 242, speech synthesizer 242 and speaker 230 of client 220. As stated above, images, e.g., graphical representations of texts (including symbols), image map regions, animation (e.g., animated GIFs), applets and programmatic objects, ASCII art, frames, scripts, images used as list bullets, spacers, graphical buttons, may be stored in image files in the HTML file forwarded to client 220. For example,

<IMG SRC=“warning.gif”>

in the HTML source code may indicate that the image SRC may be found in the file warning.gif where “.gif” indicates that the image is stored in the file format of GIF.

In step 402, web browser 221 of client 220 may be configured to scan the HTML source code line by line for an image file tag that identifies a particular image file. For example,

<IMG SRC=“warning.gif”>

in the HTML source code is an image file tag that may indicate that the image SRC may be found in the file warning.gif where “.gif” indicates that the image is stored in the file format of GIF.

In step 403, a determination may be made as to whether an image file tag was identified. If an image file tag was not identified, then method 400 may be terminated in step 411.

In step 404, if an image file tag was identified, then web browser 221 may be configured to open the image file associated with the image file tag identified in step 403. Upon opening the image file associated with the image file tag, web browser 221 may be configured to transmit the image associated with the opened image file to an OCR scanning program 222 in step 405. In one embodiment, OCR scanning program 222 resides in client 220. In another embodiment, OCR scanning program 222 may be a plug-in to web browser 221. In another embodiment, OCR scanning program 222 may be directly incorporated as an option in web browser 221. In another embodiment, OCR scanning program 222 may reside in web server 210. In another embodiment, OCR scanning program 222 may reside in a different client 220 with respect to client 220 comprising web browser 221.

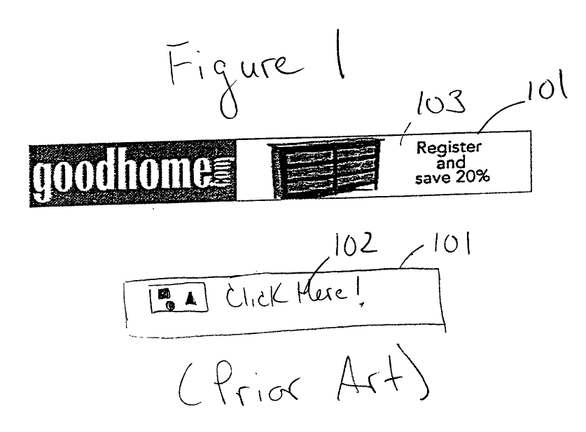

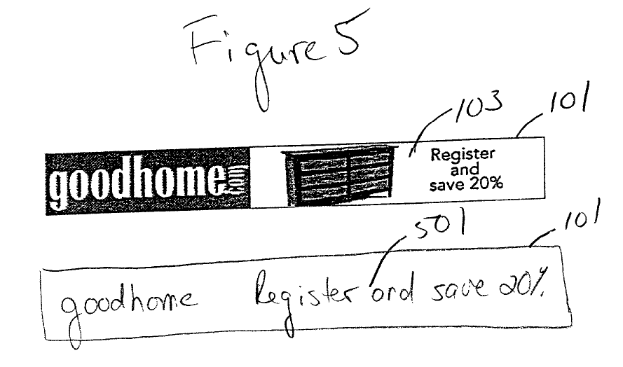

In step 406, the image transmitted to OCR scanning program 222 in step 405 may be scanned for textual information in the image. The textual information scanned by OCR scanning program 222 in step 405 may be stored in a file in step 407. OCR scanning program 222 may then transmit the file comprising the textual information in the image scanned to web browser 221 in step 408. For example, FIGS. 1 and 5 illustrate an image 103, e.g., banner ad, that may be displayed on a web page. As stated above, when web browser 221 is operating in “text only” mode, the web browser 221 may simply display the attribute, e.g., ALT attribute, associated with the image. For example, web browser 221 may simply display “Click Here!” 102 in the place holder of the image 101 instead of image 103 as illustrated in FIG. 1. When OCR scanning program 222 receives the image, e.g., image 103, from web browser 221, OCR scanning program 222 scans the image for textual information, e.g., “goodhome Register and save 20%”. OCR scanning program 222 may then store the textual information scanned in a file that may be transmitted to web browser 221.

In step 409, web browser 221 operating in “text only” mode may then be configured to output the textual information received from OCR scanning program 222 to display 338 and/or Braille display 342 and/or speech synthesizer 344 and/or speaker 330 of client 220. An example of web browser 221 outputting the textual information received from OCR scanning program 222 to display 338 is illustrated in FIG. 5. FIG. 5 illustrates that the textual information 501, e.g., “goodhome Register and save 20%”, received from OCR scanning program 222 may be inserted in the place holder 101 for the image thereby providing more information than simply displaying an attribute, e.g., “Click Here!”, when images are turned off in web browser 221, i.e. when web browser 221 is operating in “text only” mode.

By outputting the textual information of the image, e.g., graphical representations of texts (including symbols), image map regions, animation (e.g., animated GIFs), applets and programmatic objects, ASCII art, frames, scripts, images used as list bullets, spacers, graphical buttons, in the image file identified in step 403 to speech synthesizer 344 and/or speaker 330, a blind person may now be able to hear enough textual information to adequately describe the image, e.g., advertising banner ad, displayed on a web page. By outputting the textual information of the image, e.g., graphical representations of texts (including symbols), image map regions, animation (e.g., animated GIFs), applets and programmatic objects, ASCII art, frames, scripts, images used as list bullets, spacers, graphical buttons, in the image file identified in step 403 to Braille display 343, a blind person may now be able to read enough textual information to adequately describe the image, e.g., advertising banner ad, displayed on a web page. In one embodiment, web browser 221 may be configured to output the textual information in the image received from OCR scanning program 222 in addition to the attributes, e.g., ALT attributes, associated with the image, to display 338 and/or Braille display 342 and/or speech synthesizer 344 and/or speaker 330 of client 220.

In step 410, a determination may be made as to whether web browser 221 has finished scanning the entire HTML file forwarded to web browser 221 by web page engine 211 of web server 210 in step 401. If so, then method 400 may be terminated in step 411. If not, then web browser 221 of client 220 may be configured to scan additional lines in the HTML source code line by line for an image file tag that identifies a particular image file in step 402.

It is noted that the steps of method 400 may be implemented exclusively by web browser 221 which may reside in application 360 or disk units 320. ID one embodiment, OCR scanning program 222 may be a plug-in to web browser 221. in another embodiment, OCR scanning program 222 may be directly incorporated as an option in web browser 221. In another embodiment, OCR scanning program 222 may reside in web server 210. In another embodiment, OCR scanning program 222 may reside in a different client 220 with respect to client 220 comprising web browser 221. It is further noted that the steps of method 400 may be implemented by OCR scanning program 222 in conjunction with web browser 221 as stated above where both OCR scanning program 222 and web browser 221 may reside in application 360 or disk units 320.

Although the system, computer program product and method are described in connection with several embodiments, it is not intended to be limited to the specific forms set forth herein, but on the contrary, it is intended to cover such alternatives, modifications, and equivalents, as can be reasonably included within the spirit and scope of the invention as defined by the appended claims. It is noted that the headings are used only for organizational purposes and not meant to limit the scope of the description or claims.

1. A method for scanning and outputting textual information in web page images comprising the steps of:
receiving a file specifying one or more images files;
opening one of said one or more image files;
transmitting an image associated with said one of said one or more image files to a scanning program;
scanning said image for textual information in said image; and
transmitting said textual information of said image to a web browser.

2. The method as recited in claim 1 further comprising the step of:
scanning said file for an image file tag.

3. The method as recited in claim 2, wherein said image file tag identifies said one of said one or more image files.

4. The method as recited in claim 1 further comprising the step of:
storing said textual information in said image scanned in a file.

5. The method as recited in claim 4, wherein said textual information of said image is transmitted to said web browser in said file.

6. The method as recited in claim 1 further comprising the step of:
outputting said textual information of said image to a speech synthesizer.

7. The method as recited in claim 1 further comprising the step of:
outputting said textual information of said image to a Braille display.

8. The method as recited in claim 1 further comprising the step of:
outputting said textual information of said image to a speaker.

9. The method as recited in claim 1, wherein said scanning program is an optical character recognition scanning program.

10. A computer program product having a computer readable medium having computer program logic recorded thereon for scanning and outputting textual information in web page images, comprising
programming operable for receiving a file specifying one or more images files;
programming operable for opening one of said one or more image files;
programming operable for transmitting an image associated with said one of said one or more image files to a scanning program;
programming operable for scanning said image for textual information in said image; and
programming operable for transmitting said textual information of said image to a web browser.

11. The computer program product as recited in claim 10 further comprising:
programming operable for scanning said file for an image file tag.

12. The computer program product as recited in claim 11, wherein said image file tag identifies said one of said one or more image files.

13. The computer program product as recited in claim 11 further comprising:
programming operable for storing said textual information in said image scanned in a file.

14. The computer program product as recited in claim 13, wherein said textual information of said image is transmitted to said web browser in said file.

15. The computer program product as recited in claim 10 further comprising:
programming operable for outputting said textual information of said image to a speech synthesizer.

16. The computer program product as recited in claim 10 further comprising:
programming operable for outputting said textual information of said image to a Braille display.

17. The computer program product as recited in claim 10 further comprising:
programming operable for outputting said textual information of said image to a speaker.

18. The computer program product as recited in claim 10, wherein said scanning program is an optical character recognition scanning program.

19. A system, comprising:
a web server configured to provide access to a web page;
a client coupled to said web server, wherein said client comprises:
a processor;
a memory unit operable for storing a computer program operable for scanning and outputting textual information in web page images;
an input mechanism;
an output mechanism; and
a bus system coupling the processor to the memory unit, input mechanism, and output mechanism, wherein the computer program is operable for performing the following programming steps:
receiving a file specifying one or more images files;
opening one of said one or more image files;
transmitting an image associated with said one of said one or more image files to a scanning program;
scanning said image for textual information in said image; and
transmitting said textual information of said image to a web browser.

20. The system as recited in claim 19, wherein the computer program is further operable to perform the following programming step:
scanning said file for an image file tag.

21. The system as recited in claim 20, wherein said image file tag identifies said one of said one or more image files.

22. The system as recited in claim 19, wherein the computer program is further operable to perform the programming step:
storing said textual information in said image scanned in a file.

23. The system as recited in claim 23, wherein said textual information of said image is transmitted to said web browser in said file.

24. The system as recited in claim 19, wherein the computer program is further operable to perform the following programming step:
outputting said textual information of said image to a speech synthesizer.

25. The system as recited in claim 19, wherein the computer program is further operable to perform the following programming step:
outputting said textual information of said image to a Braille display.

26. The system as recited in claim 19, wherein the computer program is further operable to perform the following programming step:
outputting said textual information of said image to a speaker.

27. The system as recited in claim 19, wherein said scanning program is an optical character recognition scanning program.
